(19) United States
(12) Patent Application Publication
(10) Pub. No.: US 2013/0097333 A1
(43) Pub. Date: Apr. 18, 2013

(54) METHODS AND APPARATUSES FOR UNIFIED STREAMING COMMUNICATION

(71) Applicants: Tracy A. Bathurst, South Jordan, UT (US); Derek Graham, South Jordan, UT (US); Michael Braithwaite, Round Rock, TX (US); Russel S. Ericksen, Spanish Fork, UT (US); Brett Harris, Orem, UT (US); Sandeep Kalra, Salt Lake City, UT (US); David K. Lambert, South Jordan, UT (US); Peter H. Manley, Draper, UT (US); Ashutosh Pandey, Murray, UT (US); Bryan Shaw, Morgan, UT (US); Darrin T. Thurston, Liberty, UT (US); Michael Tilelli, Syracuse, UT (US); Paul R. Bryson, Austin, UT (US)

(72) Inventors: Tracy A. Bathurst, South Jordan, UT (US); Derek Graham, South Jordan, UT (US); Michael Braithwaite, Round Rock, TX (US); Russel S. Ericksen, Spanish Fork, UT (US); Brett Harris, Orem, UT (US); Sandeep Kalra, Salt Lake City, UT (US); David K. Lambert, South Jordan, UT (US); Peter H. Manley, Draper, UT (US); Ashutosh Pandey, Murray, UT (US); Bryan Shaw, Morgan, UT (US); Darrin T. Thurston, Liberty, UT (US); Michael Tilelli, Syracuse, UT (US); Paul R. Bryson, Austin, UT (US)

(73) Assignee: CLEARONE COMMUNICATIONS, INC., Salt Lake City, UT (US)

(21) Appl. No.: 13/494,779

(22) Filed: Jun. 12, 2012

Related U.S. Application Data
(60) Provisional application No. 61/496,022, filed on Jun. 12, 2011.

(51) Int. Cl. H04L 29/06

(52) U.S. Cl. CPC H04L 29/06027
USPC 709/231

(57) ABSTRACT

Embodiments include methods, computer-readable media, and apparatuses for supporting unified streaming communications. A communication apparatus is configured to communicate over a network to incorporate a wide variety of protocols and peripheral devices for use in audio, video, and media communication systems.

### CROSS-REFERENCE TO RELATED APPLICATIONS

This application claims the benefit of: U.S. Provisional Patent Application Ser. No. 61/496,6022, filed Jun. 12, 2011 and entitled “Streaming Unified Communications System,” the disclosure of which is incorporated herein in its entirety by this reference. This application is further related to U.S. Patent App. Ser. No. 61/443,471, filed 16 Feb. 2011, which is incorporated herein in its entirety by this by reference.

### TECHNICAL FIELD

Embodiments of the present disclosure relate generally to communication systems. More specifically, embodiments of the present disclosure relate to methods and apparatuses for streaming unified communication systems.

### BACKGROUND

A goal of unified communication is to enable users to reach and collaborate more timely with remote and mobile co-workers, decision makers, and customers, which improves productivity and efficiency and results in better communication and faster decision-making. Unified Communication creates the opportunity to experience these benefits through the integration of real-time communications services including: Video & Audio Conferencing, Scheduling, Whiteboards, Presence/IM, Unified Messaging, Voice over Internet Protocol (VoIP), peer-to-peer voice, and PSTN termination/origination.

Today, unified communications is a vibrant technology, yet it is mired in a fragmented ecosystem. The goal of a seamless company-to-company communications (inter-domain federation), as well as that within a company (intra-domain federation), from one vendor's equipment to another remains elusive. To fully realize the opportunity that exists for Unified Communication, inter-vendor interoperability must be addressed within the industry.

Various unified communication vendors have their historical roots in different aspects of communications (e.g. telephony, video, devices, etc.) and are struggling to remain relevant in the unified communication era where few vendors provide an end-to-end solution. Even those vendors that offer a full suite of unified communication products, find that their customers have existing investments in a range of vendor equipment within their technology portfolios.

### BRIEF DESCRIPTION OF THE SEVERAL VIEWS OF THE DRAWINGS

FIG. 1 is a block diagram illustrating a communication apparatus according to one or more embodiments of the present disclosure;

FIG. 2 illustrates a typical unified communication system;

FIG. 3 illustrates audio distribution components and capabilities over a network;

FIG. 4 illustrates an inter-campus conferencing system;

FIG. 5 illustrates an inter-room conferencing system;

FIG. 6 illustrates an inter-room conferencing system;

FIG. 7 illustrates an Personal Computer (PC) based unified communication client;

FIG. 8 illustrates an embodiment of a peer-to-peer network relationship; and

FIG. 9 illustrates a high-level firmware architecture.

### DETAILED DESCRIPTION

In the following description, reference is made to the accompanying drawings in which is shown, by way of illustration, specific embodiments of the present disclosure. The embodiments are intended to describe aspects of the disclosure in sufficient detail to enable those skilled in the art to practice the invention. Other embodiments may be utilized and changes may be made without departing from the scope of the disclosure. The following detailed description is not to be taken in a limiting sense, and the scope of the present invention is defined only by the appended claims.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor is configured to execute instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

In addition, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be rearranged.

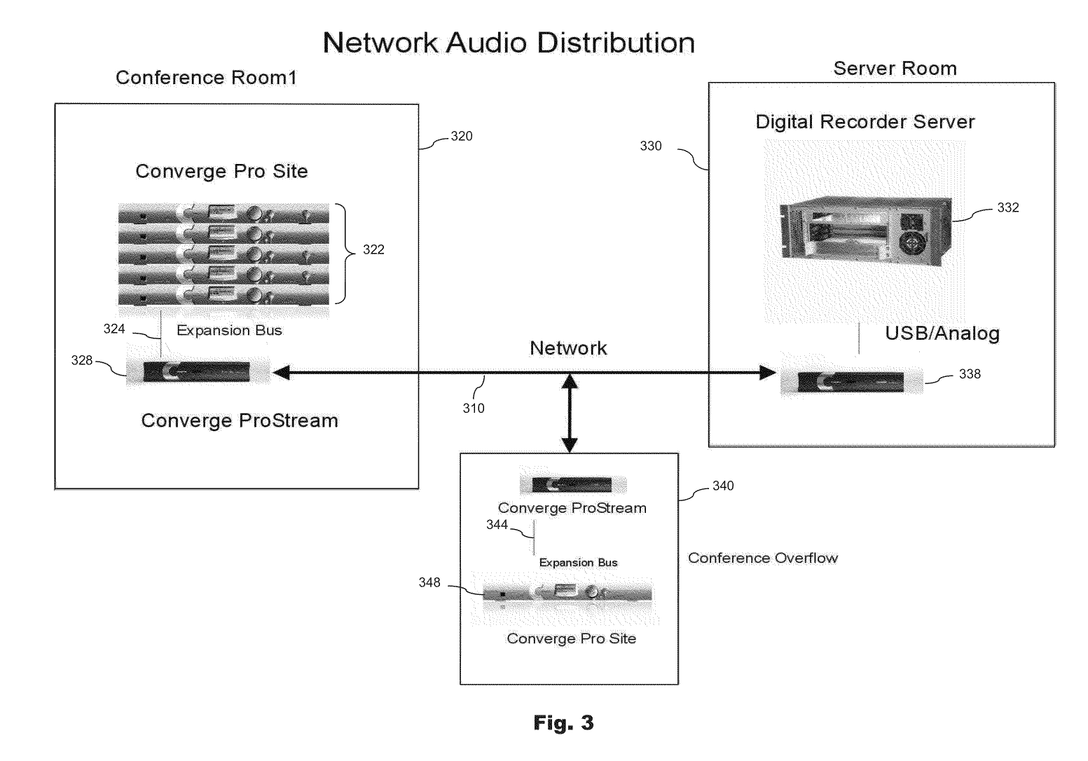

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. For example, where feasible elements in FIG. 3 are designated with a format of 3xx, where 3 indicates FIG. 3 and xx designates the unique element. In some cases, element numbers may not be included for some elements where the numbers may obscure the drawing and the element will be readily apparent from the detailed description of the drawing.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

Headings may be included herein to aid in locating certain sections of detailed description. These headings should not be considered to limit the scope of the concepts described under any specific heading. Furthermore, concepts described in any specific heading are generally applicable in other sections throughout the entire specification.

This disclosure may reference the terms, “Converge ProStream” and “Converge ProCOM,” which has been employed by the inventors as project titles for at least some of the subject matter of this disclosure. The terms, “Converge ProStream,” and “Converge ProCOM” may also generally refer to a communication system and related terms, as shown in the drawings and described herein and the term “Converge Pro” is used generically to refer to “Converge ProStream” and “Converge ProCOM”. Therefore, “Converge Pro,” “Converge ProStream” and “Converge ProCOM” should not be interpreted to have any meaning or functionality not related to what is described herein through the various examples.

Unified communication implementations present similar functionality and user experiences yet the underlying technologies are diverse, supporting multiple protocols that include: XMPP; SIMPLE for IM/P; H.323, SIP, XMPP/Jingle for Voice & Video. Additionally, there are disparate protocols for Data Conferencing Multiple Codec's used for voice and video: e.g., G.711/729, H.263/264, etc. Finally, there are many proprietary media stack implementations addressing IP packet loss, jitter and latency in different ways.

Unified communications (UC) is the integration of real-time communication services such as instant messaging (chat), presence information, telephony (including IP telephony), video conferencing, call control and speech recognition with non-real-time communication services such as unified messaging (integrated voicemail, e-mail, SMS and fax). UC is not a single product, but a set of products that provides a consistent unified user interface and user experience across multiple devices and media types.

UC also refers to a trend to offer Business process integration, i.e. to simplify and integrate all forms of communications in view to optimize business processes and reduce the response time, manage flows, and eliminate device and media dependencies.

UC allows an individual to send a message on one medium and receive the same communication on another medium. For example, one can receive a voicemail message and choose to access it through e-mail or a cell phone. If the sender is online according to the presence information and currently accepts calls, the response can be sent immediately through text chat or video call. Otherwise, it may be sent as a non real-time message that can be accessed through a variety of media.

UC is an evolving communications technology architecture which automates and unifies many forms of human and device communications in context, and with a common experience. Its purpose is to optimize business processes and enhance human communications by reducing latency, managing flows, and eliminating device and media dependencies.

Unified communications represents a concept where multiple modes of business communications can be seamlessly integrated. Unified communications is not a single product but rather a solution which consists of various elements, including (but not limited to) the following: call control and multimodal communications, presence, instant messaging, unified messaging, speech access and personal assistant, conferencing, collaboration tools, mobility, business process integration (BPI) and a software solution to enable business process integration.

The term of “presence” is also a factor—knowing where one's intended recipients are and if they are available, in real time—and is itself an notable component of unified communications. To put it simply, unified communications integrates all the systems that a user might already be using and helps those systems work together in real time. For example, unified communications technology could allow a user to seamlessly collaborate with another person on a project, even if the two users are in separate locations. The user could quickly locate the desired person by accessing an interactive directory, engage in a text messaging session, and then escalate the session to a voice call, or even a video call—all within minutes. In another example, an employee receives a call from a customer who wants answers. Unified communications could enable that worker to access a real-time list of available expert colleagues, then make a call that would reach the desired person, enabling the employee to answer the customer faster, and eliminating rounds of back-and-forth emails and phone-tag.

The examples in the previous paragraph primarily describe “personal productivity” enhancements that tend to benefit the individual user. While such benefits can be important, enterprises are finding that they can achieve even greater impact by using unified communications capabilities to transform business processes. This is achieved by integrating UC functionality directly into the business applications using development tools provided by many of the suppliers. Instead of the individual user invoking the UC functionality to, say, find an appropriate resource, the workflow or process application automatically identifies the resource at the point in the business activity where one is needed.

When used in this manner, the concept of presence often changes. Most people associate presence with instant messaging (IM “buddy lists”) the status of individuals is identified. But, in many business process applications, what is useful is finding someone with a certain skill. In these environments, presence will identify available skills or capabilities.

This “business process” approach to integrating UC functionality can result in bottom line benefits that are an order of magnitude greater than those achievable by personal productivity methods alone.

Given the sophistication of unified communications technology, its uses are myriad for businesses. It enables users to know where their colleagues are physically located (say, their car or home office). They also have the ability to see which mode of communication the recipient prefers to use at any given time (perhaps their cell phone, or email, or instant messaging). A user could seamlessly set up a real-time collaboration on a document they are producing with a co-worker, or, in a retail setting, a worker might do a price-check on a product using a hand-held device and need to consult with a co-worker based on a customer inquiry. With unified communications, instant messaging and presence could be built into the price check application, and the problem could be resolved in moments.

SIP

The Session Initiation Protocol (SIP) is an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games.

The SIP protocol is an Application Layer protocol designed to be independent of the underlying transport layer; it can run on Transmission Control Protocol (TCP), User Datagram Protocol (UDP), or Stream Control Transmission Protocol (SCTP). [2] It is a text-based protocol, incorporating many elements of the Hypertext Transfer Protocol (HTTP) and the Simple Mail Transfer Protocol (SMTP). SIP employs design elements similar to the HTTP request/response transaction model.

Each transaction consists of a client request that invokes a particular method or function on the server and at least one response. SIP reuses most of the header fields, encoding rules and status codes of HTTP, providing a readable text-based format.

SIP works in concert with several other protocols and is only involved in the signaling portion of a communication session. SIP clients typically use TCP or UDP on port numbers 5060 and/or 5061 to connect to SIP servers and other SIP endpoints. Port 5060 is commonly used for non-encrypted signaling traffic whereas port 5061 is typically used for traffic encrypted with Transport Layer Security (TLS). SIP is primarily used in setting up and tearing down voice or video calls. It has also found applications in messaging applications, such as instant messaging, and event subscription and notification. There are a large number of SIP-related Internet Engineering Task Force (IETF) documents that define behavior for such applications. The voice and video stream communications in SIP applications are carried over another application protocol, the Real-time Transport Protocol (RTP). Parameters (port numbers, protocols, codecs) for these media streams are defined and negotiated using the Session Description Protocol (SDP) which is transported in the SIP packet body.

A motivating goal for SIP was to provide a signaling and call setup protocol for IP-based communications that can support a superset of the call processing functions and features present in the public switched telephone network (PSTN). SIP by itself does not define these features; rather, its focus is call-setup and signaling. However, it was designed to enable the construction of functionalities of network elements designated proxy servers and user agents. These are features that permit familiar telephone-like operations: dialing a number, causing a phone to ring, hearing ringback tones or a busy signal. Implementation and terminology are different in the SIP world but to the end-user, the behavior is similar.

SIP-enabled telephony networks can also implement many of the more advanced call processing features present in Signaling System 7 (SS7), though the two protocols themselves are very different. SS7 is a centralized protocol, characterized by a complex central network architecture and dumb endpoints (traditional telephone handsets). SIP is a peer-to-peer protocol, thus it requires only a simple (and thus scalable) core network with intelligence distributed to the network edge, embedded in endpoints (terminating devices built in either hardware or software). SIP features are implemented in the communicating endpoints (i.e. at the edge of the network) contrary to traditional SS7 features, which are implemented in the network.

Although several other Voice over Internet Protocol (VoIP) signaling protocols exist, SIP is distinguished by its proponents for having roots in the IP community rather than the telecommunications industry. SIP has been standardized and governed primarily by the IETF, while other protocols, such as H.323, have traditionally been associated with the International Telecommunication Union (ITU).

### SIP Network Elements

A SIP user agent (UA) is a logical network end-point used to create or receive SIP messages and thereby manage a SIP session. A SIP UA can perform the role of a User Agent Client (UAC), which sends SIP requests, and the User Agent Server (UAS), which receives the requests and returns a SIP response. These roles of UAC and UAS only last for the duration of a SIP transaction.

A SIP phone is a SIP user agent that provides the traditional call functions of a telephone, such as dial, answer, reject, hold/unhold, and call transfer.

SIP phones may be implemented by dedicated hardware controlled by the phone application directly or through an embedded operating system (hardware SIP phone) or as a softphone, a software application that is installed on a personal computer or a mobile device, e.g., a personal digital assistant (PDA) or cell phone with IP connectivity. As vendors increasingly implement SIP as a standard telephony platform, often driven by 4G efforts, the distinction between hardware-based and software-based SIP phones is being blurred and SIP elements are implemented in the basic firmware functions of many IP-capable devices. Examples are devices from Nokia and Research in Motion.

Each resource of a SIP network, such as a User Agent or a voicemail box, is identified by a Uniform Resource Identifier (URI), based on the general standard syntax also used in Web services and e-mail. A typical SIP URI is of the form: sip:username:password@host:port. The URI scheme used for SIP is sip: If secure transmission is required, the scheme sips: is used and SIP messages must be transported over Transport Layer Security (TLS).

In SIP, as in HTTP, the user agent may identify itself using a message header field ‘User-Agent’, containing a text description of the software/hardware/product involved. The User-Agent field is sent in request messages, which means that the receiving SIP server can see this information. SIP network elements sometimes store this information, and it can be useful in diagnosing SIP compatibility problems.

SIP also defines server network elements. Although two SIP endpoints can communicate without any intervening SIP infrastructure, which is why the protocol is described as peer-to-peer, this approach is often impractical for a public service.

RFC 3261 defines these server elements:
A proxy server “is an intermediary entity that acts as both a server and a client for the purpose of making requests on behalf of other clients. A proxy server primarily plays the role of routing, which means its job is to ensure that a request is sent to another entity “closer” to the targeted user. Proxies are also useful for enforcing policy (for example, making sure a user is allowed to make a call). A proxy interprets, and, if necessary, rewrites specific parts of a request message before forwarding it.”
“A registrar is a server that accepts REGISTER requests and places the information it receives in those requests into the location service for the domain it handles.”
“A redirect server is a user agent server that generates 3xx responses to requests it receives, directing the client to contact an alternate set of URIs. The redirect server allows SIP Proxy Servers to direct SIP session invitations to external domains.”
The RFC specifies: “It is an important concept that the distinction between types of SIP servers is logical, not physical.”

Other SIP related network elements are Session border controllers (SBC), they serve as middle boxes between UA and SIP server for various types of functions, including network topology hiding, and assistance in NAT traversal.

Various types of gateways or bridges at the edge between a SIP network and other networks (as a phone network).

SIP Messages

SIP is a text-based protocol with syntax similar to that of HTTP. There are two different types of SIP messages: requests and responses. The first line of a request has a method, defining the nature of the request, and a Request-URI, indicating where the request should be sent.

The first line of a response has a response code.

For SIP requests, RFC 3261 defines the following methods:
REGISTER: Used by a UA to indicate its current IP address and the URLs for which it would like to receive calls.
INVITE: Used to establish a media session between user agents.
ACK: Confirms reliable message exchanges.
CANCEL: Terminates a pending request.
BYE: Terminates a session between two users in a conference.
OPTIONS: Requests information about the capabilities of a caller, without setting up a call.

The SIP response types defined in RFC 3261 fall in one of the following categories:
Provisional (1xx): Request received and being processed.
Success (2xx): The action was successfully received, understood, and accepted.
Redirection (3xx): Further action needs to be taken (typically by sender) to complete the request.
Client Error (4xx): The request contains bad syntax or cannot be fulfilled at the server.
Server Error (5xx): The server failed to fulfill an apparently valid request.
Global Failure (6xx): The request cannot be fulfilled at any server.

SIP Transactions

SIP makes use of transactions to control the exchanges between participants and deliver messages reliably. The transactions maintain an internal state and make use of timers. Client Transactions send requests and Server Transactions respond to those requests with one-or-more responses. The responses may include zero-or-more Provisional (1xx) responses and one-or-more final (2xx-6xx) responses.

Transactions are further categorized as either Invite or Non-Invite. Invite transactions differ in that they can establish a long-running conversation, referred to as a Dialog in SIP, and so include an acknowledgment (ACK) of any non-failing final response (e.g. 200 OK).

Because of these transactional mechanisms, SIP can make use of un-reliable transports such as User Datagram Protocol (UDP).

If we take the above example, User 1's UAC uses an Invite Client Transaction to send the initial INVITE (1) message. If no response is received after a timer controlled wait period the UAC may have chosen to terminate the transaction or retransmit the INVITE. However, once a response was received, User1 was confident the INVITE was delivered reliably. User1's UAC then must acknowledge the response. On delivery of the ACK (2) both sides of the transaction are complete. And in this case, a Dialog may have been established.

IM and Presence

The Session Initiation Protocol for Instant Messaging and Presence Leveraging Extensions (SIMPLE) is the SIP-based suite of standards for instant messaging and presence information. MSRP (Message Session Relay Protocol) allows instant message sessions and file transfer.

Many VoIP phone companies allow customers to use their own SIP devices, as SIP-capable telephone sets, or softphones. The market for consumer SIP devices continues to expand, there are many devices such as SIP Terminal Adapters, SIP Gateways etc.

The free software community started to provide more and more of the SIP technology required to build both end points as well as proxy and registrar servers leading to a commoditization of the technology, which accelerates global adoption. As an example, the open source community at SIPfoundry actively develops a variety of SIP stacks, client applications and SDKs, in addition to entire private branch exchange (IP PBX) solutions that compete in the market against mostly proprietary IP PBX implementations from established vendors.

The National Institute of Standards and Technology (NIST), Advanced Networking Technologies Division provides a public domain implementation of the JAVA Standard for SIP JAIN-SIP which serves as a reference implementation for the standard. The stack can work in proxy server or user agent scenarios and has been used in numerous commercial and research projects. It supports RFC 3261 in full and a number of extension RFCs including RFC 3265.

SIP-enabled video surveillance cameras can make calls to alert the owner or operator that an event has occurred, for example to notify that motion has been detected out-of-hours in a protected area.

Other protocols used in the UC Bridge are H.264 SVC (Scalable Video Coding) is a compression standard that enables video conferencing systems to achieve highly error resilient IP video transmission over the public Internet without quality of service enhanced lines. This standard has enabled wide scale deployment of high definition desktop video conferencing and made possible new architectures which reduce latency between transmitting source and receiver, resulting in fluid communication without pauses.

In addition, an attractive factor for IP videoconferencing is that it is easier to set-up for use with a live videoconferencing call along with web conferencing for use in data collaboration. These combined technologies enable users to have a much richer multimedia environment for live meetings, collaboration and presentations.

Today, most vendors provide some but not all Unified Communication products or services and have expertise in different areas of the communications. The result is a fragmented marketplace.

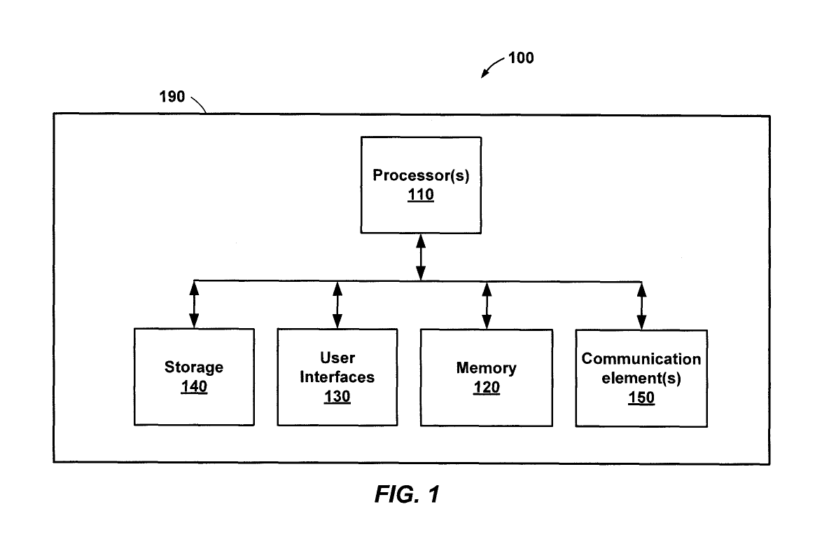

FIG. 1 illustrates a communications apparatus 100 for practicing embodiments of the present disclosure. The communication apparatus 100 may include elements for executing software applications as part of embodiments of the present disclosure. Thus, the communication apparatus 100 is configured for executing software programs containing computing instructions and includes one or more processors 110, memory 120, one or more communication elements 150, and user interface elements 130. The system 100 may also include storage 140. The communication apparatus 100 may be included in a housing 190.

As non-limiting examples, the communications apparatus 100 may be a conferencing apparatus, a user-type computer, a file server, a compute server, a notebook computer, a tablet, a handheld device, a mobile device, or other similar computer system for executing software.

The one or more processors 110 may be configured for executing a wide variety of applications including the computing instructions for carrying out embodiments of the present disclosure.

The memory 120 may be used to hold computing instructions, data, and other information for performing a wide variety of tasks including performing embodiments of the present disclosure. By way of example, and not limitation, the memory 120 may include Synchronous Random Access Memory (SRAM), Dynamic RAM (DRAM), Read-Only Memory (ROM), Flash memory, and the like.

Information related to the communication apparatus 100 may be presented to, and received from, a user with one or more user interface elements 130. As non-limiting examples, the user interface elements 130 may include elements such as displays, keyboards, mice, joysticks, haptic devices, microphones, speakers, cameras, and touchscreens.

The communication elements 150 may be configured for communicating with other devices or communication networks. As non-limiting examples, the communication elements 150 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1 a/b/g/n type wireless connections, and other suitable communication interfaces and protocols.

The storage 140 may be used for storing relatively large amounts of non-volatile information for use in the computing system 100 and may be configured as one or more storage devices. By way of example, and not limitation, these storage devices may include computer-readable media (CRM). This CRM may include, but is not limited to, magnetic and optical storage devices such as disk drives, magnetic tapes, CDs (compact disks), DVDs (digital versatile discs or digital video discs), and other equivalent storage devices.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in flow charts. Furthermore, the processes may be implemented in any suitable hardware, software, firmware, or combinations thereof.

When executed as firmware ware or software, the instructions for performing the processes may be stored on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

By way of non-limiting example, computing instructions for performing the processes may be stored on the storage 140, transferred to the memory 120 for execution, and executed by the processors 110. The processor 110, when executing computing instructions configured for performing the processes, constitutes structure for performing the processes and can be considered a special-purpose computer when so configured. In addition, some or all portions of the processes may be performed by hardware specifically configured for carrying out the processes.

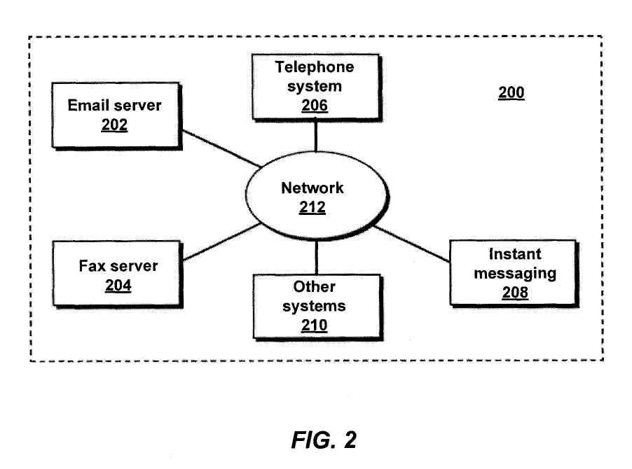

FIG. 2 illustrates a unified communication system. A typical unified communication system 200 may include one or more of the following components: email server 202, fax server 204, telephone system 206 (this system may also include voicemail and video teleconferencing), instant messaging 208, other systems 210 such as digital presence systems or systems that may in the future be part of a typical unified communication system. All of these components may communicate with each other over a LAN or WAN (such as the internet) 212 environment. One embodiment for unified the communication system 200 is that all of the components reside on the same server or cluster of servers. Another embodiment for unified the communication system 200 is for all of the components to be located in the internet “cloud.” At the present time, non-compatible unified communication systems 214 are unable to communicate and or participate in the unified communication system 200.

Embodiments of the present disclosure may be configured to improve technology through improved audio intelligibility within the group room by using capabilities, such as, for example, spatial audio techniques, beamforming technology, and improved acoustic echo cancellation (AEC) performance.

Embodiments of the present disclosure may be configured to expand applications in which communications products can be deployed in by developing differentiating features around unified communications for a group environment by capabilities, such as, for example, unified communications/VOIP, telepresence/HD video conferencing, enterprise telephony, and sound reinforcement.

Peripheral devices can be added to a unified communications mixer to create complete communication solutions. Such devices may include:
USB & Network Audio
   Converge COM—Interface box providing USB and Enterprise Headset
   Network Audio Distribution—Interface device allowing digital audio transported on standard network between Converge Pro.
Simplified Control Devices
   Network Based Key Pads—Ethernet based Keypad for controlling Converge Pro and 3rd party A/V devices.
   Tabletop Controller with ability to control other A/V devices
   Software Based Mixer Console—Software application allowing users to create mixing consoles on standard PC.
Microphone Devices
   Beamforming Microphone—Ceiling, Tabletop, and Wall mounted microphones systems that improves audio intelligibility in conferencing applications.
   Microphone Breakout Box with Cat 5-Microphone Interface Box that allows Microphone inputs to be carried to Converge Pro mixers over standard Cat 5 Cable.
Audio Amplifier Devices—Multichannel Audio Amplifier with Network Audio capabilities.

Embodiments of the present disclosure may be configured to
Incorporate the Multichannel AEC Algorithm into the Converge Pro mixers
   Provides Key Differentiator in HD Video and Telepresence Applications.
Develop Communication Interface Device similar to Interact COM
   Provides USB Audio and Enterprise Telephone Set interface into Converge Pro
   Leverage UC Market Growth to include Microsoft OCS.
Develop Network Audio Device for Converge Pro to compete with CobraNet solutions on market
   Incorporate NetStream's Technology into Converge Pro platform
   Utilize Network Audio to get “New Beamforming Microphone” into Converge Pro

Converge ProStream communication systems may include a number of peripheral devices. As noon-limiting examples, some of these peripherals are a Converge ProStream BFM (Beam Forming Microphone), a Converge ProStream Mic, a Converge ProStream Out, and a Converge ProStream Amp.

The Converge ProStream BFM may include a beamforming microphone solution that facilitates ceiling, wall, and table mount installation. Audio performance may have similar sensitivity as a table boundary microphone without noise contribution. Typical talker to microphone distance will be about 10-feet. The beamforming microphone will implement AEC algorithms, NetStream's network audio, and Power over Ethernet (POE).

The Converge ProStream Mic is a 4 channel Microphone/Line Input devices that incorporates NetStream's network Audio. It may be powered by POE and include the ClearOne microphone processing chain with an AEC.

The Converge ProStream Out includes a 4 channel line output devices that incorporates NetStream's network Audio. It may be powered by POE and include the ClearOne PA output processing chain including feedback elimination.

The Converge ProStream Amp includes 4 channel power amplifier devices that incorporates NetStream's network Audio and may include will include the ClearOne PA output processing chain including feedback elimination.

Converge ProStream communication systems may include a number of peripheral devices. As noon-limiting examples, some of these control devices are a touch panel allow direct control of the Converge Pro product line and also select video conferencing and other A/V devices and a network keypad.

Converge Pro systems cover at least three product lines defined as Converge ProStream, Converge ProCom, and Converge Pro BFM. Converge ProStream includes a digital audio encoder/decoder for network transport with an expansion bus interface. Converge ProCom includes USB and Headset audio to a Converge Pro site. Converge ProStream BFM includes beamforming microphones with AEC that connect to a ProStream Codec.

The Converge ProStream system includes eight channels of digital audio input, eight channels of digital audio output, four channels of line level input, four channels line level output, two bidirectional channels of USB audio of. Digital audio channels shall be transported via NetStream's protocol utilizing the rear panel RJ-45 network connector supporting a 10/100 Ethernet connection. Digital audio may be sampled at 44.1 KHZ with a 24 bit resolution.

Analog line input and output may be provided on the rear panel with, for example, 2.5 mm Euro plugs in a balanced topology. The ProStream system may be interfaced to a Converge Pro audio mixer via a mix-minus expansion bus utilizing an RJ-45 Link In and an RJ-45 Link Out connection. Network and USB audio may be sample rate converted to 48 KHZ for direct interface with the Converge Pro audio mixers.

The Converge ProStream system may include, but not be limited to, the following signal processing functions: Matrix Mixer, Gating Mixer, Gain functions, Mute functions, Filter functions, Compressor Functions,

The Converge ProStream system may be programmed and configured with Converge Console software applications via USB or Ethernet connection. Table 1 defines some of the channel capabilities for a Converge ProStream system.

TABLE 1
Converge ProStream- Channel Table

| Input | Output | USB TX | USB RX | Headset | Network | Network | |
|---|---|---|---|---|---|---|---|
| Channel | Channel | Channel | Channel | Channel | TX Chan | RX Chan | G-Link |
| 4 | 4 | 2 | 2 | 1 | 8 | 8 | Yes |

The Converge ProCom system may provide two channels of bidirectional USB audio and a Headset Audio channel capable of directly interfacing to most Enterprise telephone sets. The device may also incorporate a 2.4 GHZ radio module for future control of the device from a derivative of an interact dialer product. The Converge ProCom system may interface to a Converge Pro audio mixer through the mix-minus expansion bus with a RJ-45 Link In and an RJ-45 Line Out connection.

The Converge ProCom system may include headset audio circuit may be capable of reconfiguration of RJ-9 connector to match Nortel, Avaya, Cisco, and NEC telephone sets.

The Converge ProCom system may include, but not be limited to, the following signal processing functions: Matrix Mixer, Gain functions, Mute functions, and Line Echo Cancellation.

The Converge ProCom system may be programmed and configured with the Converge Console software application via USB connection. Table 2 defines some of the channel capabilities for a Converge ProCom system.

TABLE 2
Converge ProCOM- Channel Table

| Input | Output | USB TX | USB RX | Headset | Network | Network | |
|---|---|---|---|---|---|---|---|
| Channel | Channel | Channel | Channel | Channel | TX Chan | RX Chan | G-Link |
| 0 | 0 | 2 | 2 | 1 | 0 | 0 | Yes |

The Converge ProStream BFM system may include 12 to 24 microphone elements utilizing beam forming technology to pick-up participant's audio within a conference room. The microphone audio may be transmitted to either a PC via USB connection or to a ProStream codec via network audio. The Converge ProStream BFM system may be powered utilizing 802.3af power over Ethernet circuitry. The Converge ProStream BFM includes three operational modes for creating spatial audio representation within the room. The operational modes include Mono, Stereo, and Multi-Channel (3-channels).

The Digital audio channels includes 4 channels of transmit and 4 channel of receive and may be transported via NetStream's protocol utilizing a rear panel RJ-45 network connector supporting a 10/100 Ethernet connection. Digital audio may be sampled at 44.1 KHZ with a 24 bit resolution.

The Converge ProStream BFM system may include, but not be limited to, the following signal processing functions: Beamforming Algorithm, Acoustical Echo Cancellation, Gating Mixer, Gain functions, Mute functions, and Filter functions

The Converge ProStream BFM may be designed for Table, Ceiling, or Wall mounting configuration.

The Converge ProStream BFM system may be programmed and configured with the Converge Console software application via USB or Ethernet connection. Table 3 defines some of the channel capabilities for a Converge ProCom system.

TABLE 3
Converge ProStream BFM- Channel Table

| Mic | Output | USB TX | USB RX | Network | Network | |
|---|---|---|---|---|---|---|
| Channels | Channel | Channel | Channel | TX Chan | RX Chan | G-Link |
| 12 or 24 | 0 | 2 | 2 | 8 | 8 | Yes |

FIG. 3 illustrates audio distribution components and capabilities over a network. A network 310 may connect a conference room 320, a server room 330, and a conference overflow location 340. The server room 330 may include one or more servers 332 to provide information such as, for example, audio recordings, video recordings, and other types of digital media. A Converge Pro system 338 is coupled to the servers 332 and communicates over the network 310 to one or more other communication devices. In FIG. 3, the Converge Pro system 338 communicates with a Converge Pro system 348 in the overflow location 340 and a Converge Pro system 338 in the conference room 320. The Converge Pro systems (328, 338, 348) may communicate over an expansion bus (324 and 344) to other media devices (322 and 342, respectively). These other media devices may be devices, such as, for example, computers, conferencing systems, and media recording systems, and media playback systems.

One application for the Converge ProStream systems is to facilitate audio distribution over an enterprise network between Converge Pro sites or centrally located AV equipment. Audio distribution applications would include:
Streaming Room Audio to a centralized recording equipment (Courtrooms, Distance Learning)
Streaming Room Audio to an Internet Streaming Farm for PODCAST
Streaming Room Audio to an overflow room.

The Converge ProStream systems may include line level input and outputs allowing the device to function as a head-end encoder or pure decoder within a Converge Pro system.

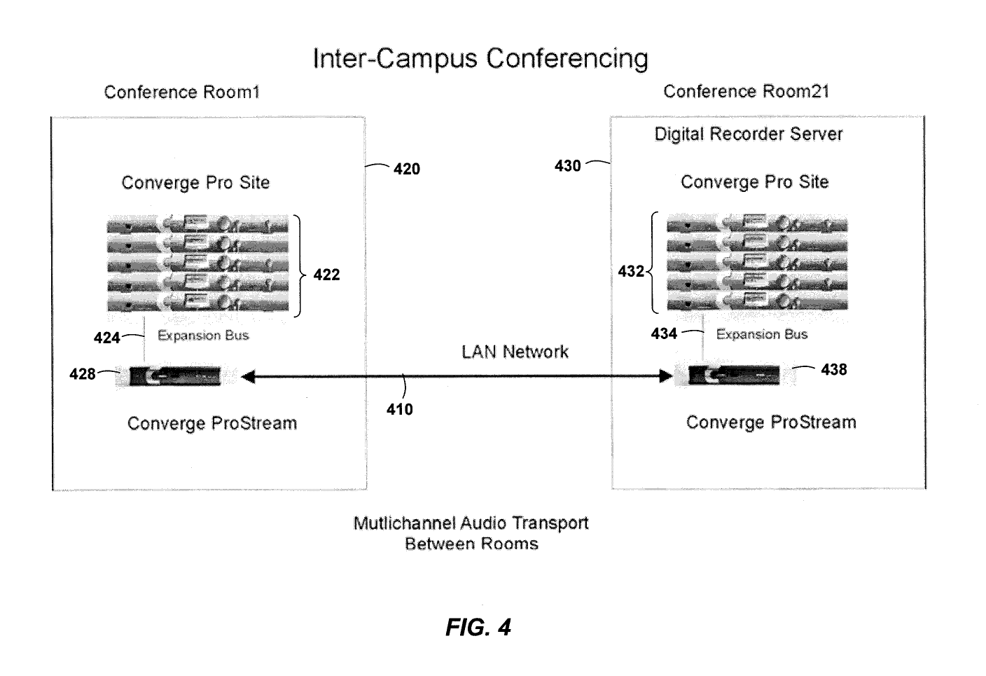

FIG. 4 illustrates an inter-campus conferencing system. A network 410 may connect a conference room 420 to another conference room 430. The Converge Pro systems (428 and 438) may communicate over an expansion bus (424 and 434) to other media devices (422 and 432, respectively). These other media devices may be devices, such as, for example, computers, conferencing systems, and media recording systems, and media playback systems.

The Converge ProStream systems enable inter-campus conferencing utilizing network audio as the primary transport method between the two rooms. A simple call protocol provides request/notification/acceptance from a user desiring to establish a call with another room within the local area network. In addition, an enhanced audio experience may be included in the transport protocol to allow multi-channel audio to be sent to the far-end providing a spatial representation at the far-end.

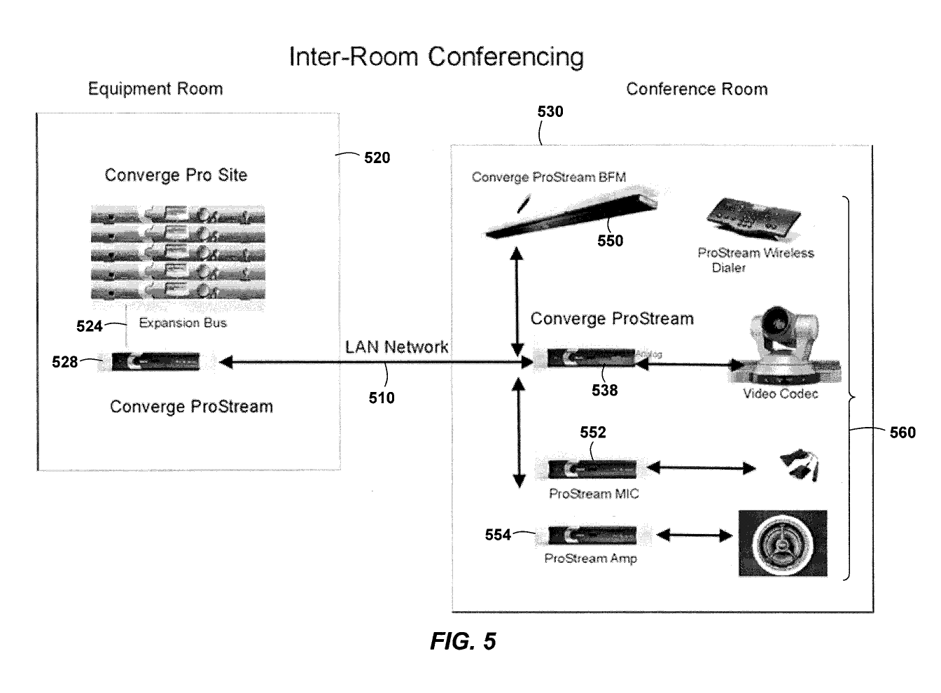

FIG. 5 illustrates an inter-room conferencing system. A network 510 may connect an equipment room 520, to a conference room 530. The equipment room 520 includes a Converge Pro system 528 coupled to the network 510 and the conference room 530 includes a Converge Pro system 538 coupled to the network 510. The Converge Pro system 528 may communicate over an expansion bus 524 to other media devices 522. These other media devices may be devices, such as, for example, computers, conferencing systems, and media recording systems, and media playback systems.

The Converge Pro systems allow utilization of standard network infrastructure for connection of A/V devices within a conference room. The ProStream beamforming microphone 550 may utilize network audio (StreamNet) for the transport method to a centralized Audio Mixer. Additional products may be added, such as, for example, a 4-Channel Amplifier 554 and a 4-Channel Microphone Interface Box 552. Various peripherals 560 may be connected to the additional products, such as, for example, wireless keyboards, video cameras and video codecs, microphones, and speakers. The room devices may be configured to interface over standard CAT 5 (or better) structured cable and support Power over Ethernet).

All the Converge ProStream systems and peripherals will include feature and functions for seamless integration into Enterprise based Unified Communication solutions. Primary interfaces will be USB audio to allow Pro Stream products to be source audio devices for UC based software clients. A second interface will be headset audio allowing the room system to be direct connected to an Enterprise telephone set.

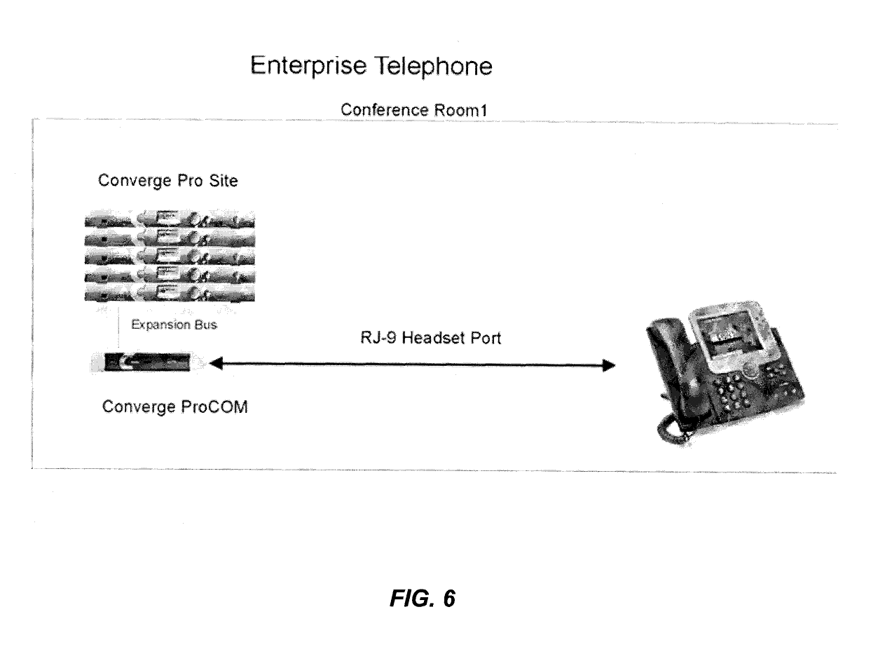

FIG. 6 illustrates an Enterprise telephone set. The Converge ProCOM system will provide direction interface to the Headset audio jack for most enterprise telephone sets. This capability allows the Converge Pro audio mixers to provide the microphone and speaker audio to the telephone set. Enabling the group conferencing system to interface with the telephone set may enhance overall user experience. The telephone may include all address books and call features typically found at the desktop allowing users to be comfortable with the interface required to establish a call.

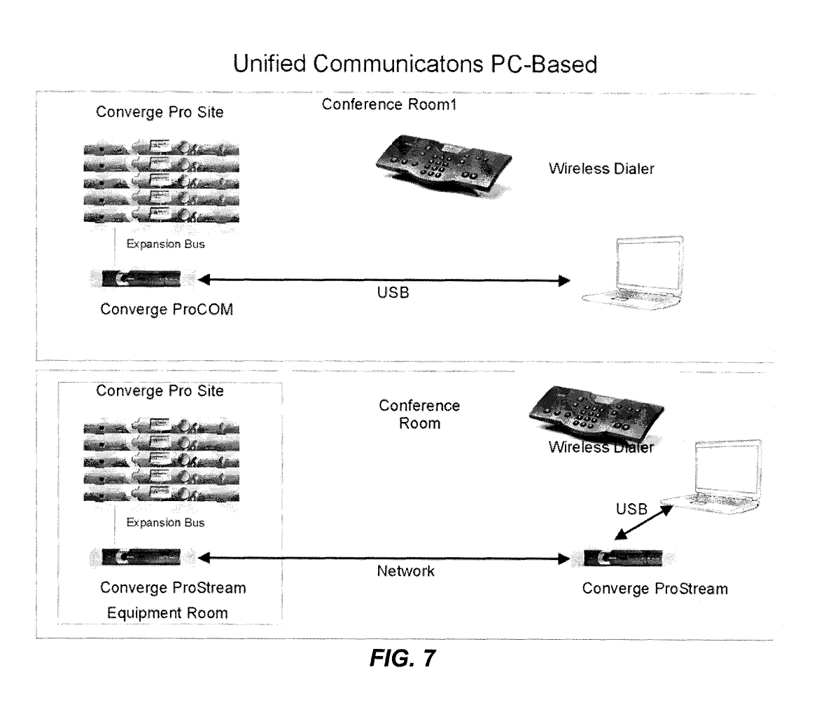

FIG. 7 illustrates an Personal Computer (PC) based unified communication system. A PC-based unified communication client typically integrates voice, video, and collaboration into a single application that can operate from a personal computer. This system allows a user to have the ability to participate in a group room environment with a software based UC session. Both the Converge ProCom and Converge ProStream systems support interfaces with the PC.

Technology, Features, and Functions

The Converge ProStream systems include network based audio transport capabilities. The transport layer may be based upon the StreamNet technology with modification to meet conference room applications and competitive products within the installed A/V market. The enterprise architecture for the Converge ProStream systems may employ both a peer-to-peer and a parent-child topology.

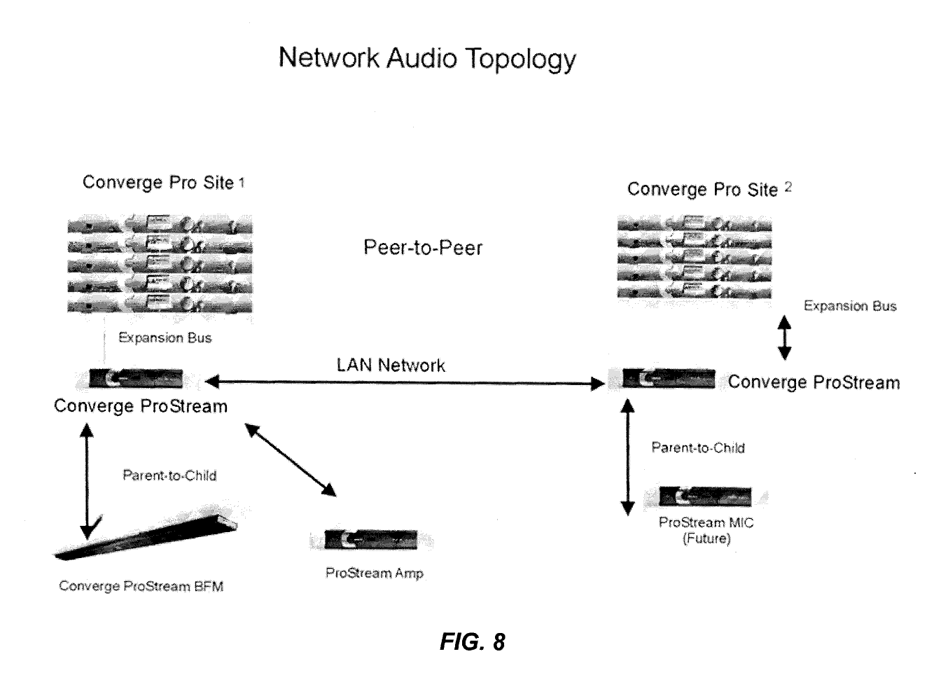

Peer-to-Peer Relationship—A peer-to-peer relationship is defined as a two separate Converge Pro Sites connected via a Converge ProStream Codec. In this scenario only audio channels and controls are shared within the connection. FIG. 8 illustrates an embodiment of a peer-to-peer network relationship.

Parent-to-Child Relationship—A parent-to-child relationship is defined as any endpoints connected to a Converge ProStream device functioning as the master network audio device in the configuration. Children devices are defined as endpoint within the conference room.

Embodiments discussed herein provide a method for multichannel HD audio transport within a local area network. This capability allows the Converge Pro audio mixers to utilize spatial audio playback within a room enhancing the overall intelligibility of the conference. However, to effectively deploy this capability within a campus a simple call protocol may be incorporated into the ProStream platform to facilitate a user to initiate or accept an invitation to establish an audio conference with another room within the Local Area network.

The call management scheme may include an Addressing/Routing method that utilizes a name association to an IP address of the ProStream device. Generally, audio streams will not be established without user acceptance of the request. Basic call states functions in the protocol may include:
Invite—An request to a specific IP address will sent to the far-end.
Notification—The far-end room will provide notification that an incoming call in form of Ringing
Busy—If room is active in another call a Busy return will be sent to requestor
Accept—User acknowledgement that incoming call audio streams should start.
End—User has terminated call and audio stream should stop.
Call Type—Sets number of Stream to the far-end (Mono, Stereo, 3-Channel)
Join—Adds another audio stream creating a bridge.

The Converge ProStream BFM system includes features to enhance audio performance. Some of these features include:
Ceiling based microphone arrays that has comparable performance of a tabletop uni-microphone.
Reduction of reverberant and noise anomalies within the talkers audio that are picked up by cardioid microphones.
Increase overall talker-to-microphone distance for adequate audio conferencing compared to table mounted cardioid microphone.
Wall/LCD Mounted microphone that may be located with a video display in a small to medium video conferencing application with maximum Talker-to-Mic distance of about 20 feet.

The Converge Pro Stream BFM system also include next generation acoustical echo cancellation algorithms. Improvement on the echo cancellation as compared to existing algorithms include:
Elimination of residual echo in single talk
Improved adaption rate to room acoustics.
Elimination of tonal anomalies in doubletalk
Addition of multichannel (3) AEC capabilities for a single input channel

Converge Pro audio mixers include new capabilities such as:
Multichannel AEC capabilities, which may be a unit mode that disables channels 5-8 on the mic inputs and reassigns processing to add 3-AEC to channels 1-4.
Matrix Mode for PreAEC/Non-Gated allows the user to change the Pre-AEC routes to either Gated (default) or Non-Gated. This will typically be used for recording applications.

Converge Console Software Application

The Converge Console application include features to allow programming and configuration of the devices. Enhancements to these features include:
Site View—A graphical vector based view that incorporates all device and audio nets associated with the site. This view will include the network audio devices.
Group View—A grouping of all similar channel types on the same pane.
NetStream Proxy Services—Functions associated with NetStream's technology will be incorporated into the software application. This will include firmware update and the device discovery network protocol.

Features by System

Table 4 defines capabilities included in the Converge ProStream systems.

TABLE 4
Converge ProStream

| Major | | |
|---|---|---|
| Assembly | Quantity | Description |
| Converge | 1 | 8-channel network-based audio codec with |
| ProStream | | expansion bus interface to Converge Pro |
| | | product line. Network audio utilizes the |
| | | StreamNet technology. |
| Power Supply | 1 | In-Line power supply 100-240 V auto |
| | | switching supply. (Need to find less |
| | | expensive supply than one used with |
| | | NetStreams. |
| RJ-45 Cable | 1 | 18″ Expansion Bus cable (Expansion Bus |
| | | Cable) |
| USB Cable | 1 | 6′ USB Cable (Type B) - Same as used on |
| | | Converge Pro mixers. |
| Phoenix | 4 | 3-Pin Euro plug for Input (Green) |
| Connector | | |
| Phoenix | 4 | 3-Pin Euro Plug for Outputs (Black) |
| Connectors | | |
| Rack Ears | 2 | Rack Ear Assembly used for the NetStream's |
| | | current ½ rack enclosure |
| Product CD | 1 | Converge Pro Product CD with new device |
| | | added. |

Table 5 defines capabilities included in the Converge ProCom systems.

TABLE 5
Converge ProCom

| Major | | |
|---|---|---|
| Assembly | Quantity | Description |
| Converge | 1 | USB and Headset Interface device with |
| ProCOM | | expansion bus interface to Converge Pro |
| | | product Lines. |
| Power Supply | 1 | In-Line power supply 100-240 V auto |
| | | switching supply. (Need to find less |
| | | expensive supply than one used with |
| | | NetStreams |
| RJ-45 Cable | 1 | 18″ Expansion Bus cable (Expansion Bus |
| | | Cable) |
| RJ-9 | 1 | 6′ RJ-9 crossover cable for Headset audio. |
| USB Cable | 1 | 6′ USB Cable (Type B) - Same as used on |
| | | Converge Pro mixers. |
| Rack Ears | 2 | Rack Ear Assembly used for the NetStream's |
| | | current ½ rack enclosure |
| Product CD | 1 | Converge Pro Product CD with new device |
| | | added. |

Table 6 defines capabilities included in the Converge ProStream BFM systems.

TABLE 6
Converge ProStream BFM

| Major | | |
|---|---|---|
| Assembly | Quantity | Description |
| Converge | 1 | 12 or 24 element Beamforming Microphone |
| ProStream | | Array with integrated Acoustical Echo |
| BFM | | Cancellation. Includes Network Audio |
| | | Output for direct connection to Converge |
| | | ProStream Codec. Device is POE based. |
| USB Cable | 1 | 15′ USB Cable (Type mini-B) - Same cable |
| | | provided for CHAT 150. |
| Product CD | 1 | Converge Pro Product CD with new device |
| | | added. |

Accessories

| | | |
|---|---|---|
| POE Injector | 1 | Power Over Ethernet injector for BFM |
| Wall Mounting | 1 | Wall Mount Kit for BFM |
| Kit | | |
| Ceiling | 1 | Ceiling Mount Kit for BFM including Tile |
| Mounting Kit | | Bridge |

The Converge ProStream system enables digital audio in the form of network based and USB based channels to be incorporated in the Converge Pro conferencing mixers. The system may be configured as a half-rack configuration or wall/table mount installations. The system incorporates NetStream's IP Audio technology for audio distribution and routing and may connect to a Converge Pro site via an expansion bus.

High level features of the Converge ProStream are shown in Table 7.

TABLE 7
Converge ProStream Features

| | Sub- | | |
|---|---|---|---|
| Category | category | Feature | Description |
| General | General | Description | The Converge ProStream is a device that |
| | | | enables the Converge Pro mixers to |
| | | | distribute audio over the Ethernet. The |
| | | | device connects via the Expansion bus to a |
| | | | Converge Pro site. The network audio |
| | | | utilizes NetStream's technology providing 8 |
| | | | encode and 8 decode channels. |
| | Pro Streams | Network Audio | 8 Encode/8 Decode Uncompressed |
| | Features | | Network Audio Channels |
| | | USB Audio | USB 2.0 Stereo Transmit and Receive |
| | | | Channels |
| | | Headset Audio | RJ-9 Interface with TX & RX for emulation |
| | | | of a Headset to a enterprise telephone set. |
| | | Line Input Audio | 4 Channels of Line Input Audio |
| | | Line Output Audio | 4 Channels of Line Output Audio |
| | | StreamNet | The network audio will utilize modified |
| | | Technology | StreamNet technology tailored for the |
| | | | Installed Audio applications. |
| | | Simple Call | A simple call management protocol will be |
| | | Management | developed allowing for spatial audio |
| | | Protocol | transport (3-Channel) between two rooms |
| | | | within the enterprise using network |
| | | | transport. The call protocol will include |
| | | | addressing/routing, call request, call receipt, |
| | | | and call termination. |
| | | Streaming (Future) | A future addition to the product is to add |
| | | | streaming capabilities with standards based |
| | | | encoding. The desire is to incorporate MP3 |
| | | | encode/decode capabilities into the product. |
| | | | Primary application will be sending |
| | | | conferencing audio to recording application |
| | | | or pod-cast on Internet. |
| | Converge | Number of | 4- ProStream Devices will be supported in a |
| | Pro Features | Supported | single site. This allows for up to 32 |
| | | ProStream Devices | Encode/Decode channels per site. |
| | | | 18- Expansion Buses |
| | | | 8- AEC Ref Channels |
| | | | 6- Global Gating Group |
| | | Audio Channel | New audio channel types will be added to |
| | | Types | include USB, Headset, and Network. |
| | | OCS Support | An OCS API will be developed for the |
| | | | Converge Pro that will allow gain, mute, |
| | | | and dialing controls via the OCS client. |
| | | | These functions will be associated with the |
| | | | USB channels. |
| | Communications | Ethernet | 10/100 Ethernet Jack with LED status |
| | | | indications |
| | | USB 2.0 | USB 2.0 with Isochronous transfer. Type B |
| | | | connector |
| | | Expansion Bus | Link In and Link Out Port with RJ-45 |
| | | | connector |
| Channels | Network | Channels | 8 Encode and 8 Decode |
| | Audio | Sample Rate | 48 KHZ with sample rate conversion for |
| | | | independent timing between Converge Pro |
| | | | and Netstreams. |
| | | Resolution | 24 Bit (16 bit?) |
| | | Processing | Gain/Mute- Channels will have gain/mute |
| | | | in network domain |
| | | | Decimation - (Will include decemination if |
| | | | using 16 bit resolution) |
| | | | MP3 (Encoder)- Future implementation |
| | | | will include MP3 encoder for Internet |
| | | | Streaming applications. |
| | | | MP3 (Decoder) -Future implementation |
| | | | will include MP3 decoder for Internet |
| | | | Streaming applications. |
| | | Controls | IP Configuration Settings- A method will be |
| | | | developed to configure IP settings for the |
| | | | ProStream devices. |
| | | | Channel Addressing- A method will be |
| | | | developed to identify audio channels. |
| | | | Channel Routing- A method will be |
| | | | developed to route individual audio |
| | | | channels to ProStream devices. |
| | | | Audio Packet Statistics- A method will be |
| | | | developed to identify TX, RX, and packet |
| | | | loss on the network. |
| | | | C1 Channel Control API- A method will be |
| | | | developed to send device control |
| | | | information associated with the audio |
| | | | channel type to other ProStream devices. |
| | | | Call Management Function- A simple |
| | | | protocol will be developed that facilitate |
| | | | spatial audio transport between two or more |
| | | | ProStream devices. |
| | | | MP3 Control (Future)- Start, Stop, FF, etc |
| | | Network Standards | IPV4- Device will be compatible with IPV4 |
| | | | ICMPV3- Device will be compatible with |
| | | | ICMPV3. |
| | | Timing | Maximum Master Clock Drift = <2 usec |
| | | Synchronization | (Implementation will use sample rate |
| | | | converters. Timing accuracy is focused on |
| | | | AEC performance) |
| | | Codec Delay | Maximum Encode/Decode Delay = <30 msec |
| | Future | IPV6 | Eventually the ProStream products will |
| | Network | | support IPV6. This will include |
| | Audio | | incorporating features sets that enhance |
| | | | capabilities for network audio. This would |
| | | | include QOS, Security, and Traversal |
| | | | features inherent to IPV6. |
| | | 802.1 Q & p | The ProStream product will need to support |
| | | | VLan Tagging and packet priority. |
| | | IPSec | The ProStream product will need to support |
| | | | IPSec for security. |
| | | RSVP | The ProStream product will need to support |
| | | | RSVP for QOS delivery in streaming |
| | | | applications |
| | | DiffServ | The ProStream will need to support |
| | | | DiffServ for stream priority in QOS. |
| | | Time | The desire is to eventually create a network |
| | | Synchronization | timing source based upon 48 KHz sample |
| | | | rate that would have maximum clock drift of |
| | | | <500 nsec. This will allow elimination of |
| | | | sample rate conversion within professional |
| | | | product. |
| | | Encoding/Decoding | The desire is to develop network audio |
| | | Delay | scheme with <5 usec delay from encode to |
| | | | decode. (not including network delay) |
| | USB Audio | Number | Stereo Transmit & Receive |
| | | Sample Rate | 48 KHZ with Sample Rate Conversion for |
| | | | independent timing between PC and |
| | | | Converge |
| | | Resolution | 24 bit |
| | | Driver | USB Audio Device |
| | | | OCS Audio Device |
| | | | USB HID Device |
| | | | Bulk Transfer (Firmware Loading) |
| | | | (Windows XP, Vista, Win 7, Mac OS 10) |
| | | HID Functions | Gain/Mute- gain and mute functions |
| | | | Dialing Controls- Dialing, On/Off Hook, |
| | | | Redial |
| | | | Firmware Update- Method for USB |
| | | | firmware update for driver specific |
| | | | functions. |
| | | | OCS or Standard USB Mode |
| | Expansion | I-Z Buses | 16- Expansion Bus to include both To |
| | Bus Audio | | (output) and From (input) channels that can |
| | | | be routed to network audio slots or usb |
| | | | audio slots. |
| | | Expansion Bus | 8- Expansion Bus Reference Channels. |
| | | References | Channels would be routed based in Network |
| | | | audio slots or USB audio slots |
| | | Global Gating | 6- Global Gating Groups |
| | | Groups | |
| | | Control Slot | 2- Control Slots for inner unit command and |
| | | | control. |
| | Headset | Coarse Gain | The coarse gain settings for the headset will |
| | Channel | | be based upon some pre-defined analog gain |
| | | Headset | Headset Configurations for Cisco, Avaya, |
| | | Configuration | Nortel |
| | | PinOut | Pinout for RJ-9 based upon manufacture |
| | | | headset port. |
| | | Fine Gain | −20 to 0 dB (Need to determine through |
| | | | testing) |
| | | Mute | Toggle On/Off for TX and RX |
| | | Receive ALC | Receive ALC |
| | | TEC | Line Echo Cancellation for side-tone |
| | | | elimination on headset port. |
| | | TEC NLP | Line Non-Linear Processing- Some phone |
| | | | configurations require only NLP to be |
| | | | enabled. |
| | Inputs | Number | 4-channels |
| | Channels | Input Impedance | 5K ohm |
| | | Frequency | 20 Hz to 20 kHz |
| | | Response | |
| | | Connector | 3-Pin Euro (mini-Phoenix) Black |
| | | Max Input Level | +20 dBu |
| | | THD + N | <.02% |
| | | Cross Talk | <−91 dB at max gain |
| | | Dynamic Range | 100 dB |
| | Line Output | Number | 4Channels |
| | | Connector | Mini-Phoenix (Black) |
| | | Impedance | 47.7 Kohm |
| | | Frequency | 20 Hz to 20 KHz |
| | | Response | |
| | | THD + N | <.02% |
| | | Dynamic Range | 100 dB (non-weighted) |
| | | Cross Talk | <−91 dB at max Gain |
| Processing | Matrix | Size | Inputs |
| | | | 16- Expansion Bus (From) |
| | | | 2- USB RX (Left &Right) |
| | | | 8- Network Audio RX (Gated) |
| | | | 8- Network Audio RX (Non Gated) |
| | | | 4- Line Inputs |
| | | | 36 Total |
| | | | Output |
| | | | 16- Expansion Bus (To) |
| | | | 8- USB TX (Left & Right) |
| | | | 4- Line Outputs |
| | | | 8- Expansion Bus Ref Channels |
| | | | 8- Network Audio TX |
| | | | 40 Total |
| | | Cross Point Control | +12 dB to −65 dB |
| | | Gated or Non- | Gated or Non-Gated Inputs |
| | | Gated | |
| | AutoMixer | 6- Global Gating | Device will support global gating groups |
| | | Groups | |
| | | 2- Internal Groups | Device will support 2 Internal Gating |
| | | | groups |
| | | 1^{st} Mic Priority | Device will support 1^{st} mic priority scheme. |
| | | Proportional (TBA) | Potential inclusion of proportional gating |
| | | | algorithm |
| | Network | Gain | +20 dB to −65 dB |
| | Audio | Mute | Mutes individual network audio channel |
| | Channels | Delay | 50 millisecond delay block that can be used |
| | | | for time alignment when used in-room |
| | | | designs. |
| | | MPEG Encoder | Future addition of MPEG Encoder (desire |
| | | | would be to include encoder for each |
| | | | channel-8) |
| | | MPEG Decoder | Future addition of MPEG decoder (desire |
| | | | would be to include decoder for each |
| | | | channel) |
| | USB Audio | Volume | PC controlled volume |
| | Channels | Balance | PC Controlled Left & Right Balance |
| | | Mute | Global Mute |
| | Headset | Line Echo | Line Echo Cancellation for Side-tone |
| | Audio | Cancellation | elimination on unit |
| | | NLP | Non Linear Suppression for Side-tone |
| | | | elimination |
| | | NC | Receive Noise Cancellation |
| | | Gain | Digtial gain stage |
| | | Mute | Mute |
| | | Receive ALC | Receive ALC |
| | Mic Inputs | AEC | New Multichannel AEC |
| | (Future) | Gain | +55 to −65 in 1 dB increments (combine |
| | | | coarse & fine gain) |
| | | Filter Block | 4- Node |
| | | NC Block | Noise Cancellation Block |
| | | Mute | Toggle On/Off |
| | | ALC | Automatic Gain Block |
| | Output | Mute | Toggle On/Off |
| | channels | DigitalGain | +20 to −65 dB |
| | | AEC Reference | Sends gain changes to AEC to mitigate |
| | | Tracking | suppression. |
| | | Stereo Mode | Pair Channels through Matrix for stereo |
| | | | operations |
| | | 16 Node EQ Filter | EQ Filter for Speaker Matching and |
| | | | developing Cross-Over Filters |
| | | Compressor/Limiter | Each output will have compressor/limiter |
| | | | within signal chain. |
| | | Delay | 0-250 mSec Delay |
| | | Noise Gate | User selectable noise gate with ability to set |
| | | | threshold, attach rate, gate ratio |
| | | Feedback | 16-node feedback elimination |
| | | Elimination | |
| Configuration/ | NetStreams | General | Network based audio transport technology. |
| Management | Configuration | Time | Site Timing master for network audio |
| | | Synchronization | synchronization. |
| | | Network | Network Configuration and routing utilizing |
| | | Configuration & | Multicast protocol |
| | | Routing | |
| | | NetStream | Automatic identification of NetStreams |
| | | Discovery | enabled devices on the network. |
| | | NetStream | Method for firmware update to NetStreams |
| | | Firmware Update | enabled devices on the network and |
| | | | associated with a site. |
| | | System Diagnostic | Status Checks on activity of NetSteams |
| | | | enabled devices |
| | Converge | Scalability | Link up to 4-Converge ProStream into a |
| | ProStream | | single site for 32 Inputs and 32 Outputs of |
| | Configuration | | network audio channels. Multicast channels |
| | Functions | | to any ProStream enabled products for |
| | | | ultimate scalability. |
| | | Unit Settings | Unit setting will for the ProStream device |
| | | | will include device addressing and all |
| | | | communication setting for the device |
| | | Channel Settings | Channel Settings will include all properties |
| | | | associated with the USB, Network, Headset |
| | | | and Expansion Bus audio channels. |
| | | Matrix Routing | Matrix routing will include all settings |
| | | | associated with audio routing from Input to |
| | | | Output channels to include the auto-mic |
| | | | mixer. |
| | | Macro | Up to 256 macros will be supported on the |
| | | | device |
| | | Presets | Up to 32 presets will be supported on the |
| | | | device |
| | | Event Scheduler | Up to 10 Events can be scheduled through |
| | | | the event scheduler function. |
| | | System Diagnostics | A system diagnostic function will be |
| | | | developed which will include |
| | | | NetStream Device Status |
| | | | Network Loop Test with Packet Status |
| | | Device Log | A device log will be included that allows |
| | | | user to enable disable recording of key |
| | | | events that may occur on the platform or |
| | | | NetStreams enable children devices |
| | | Event Log | An event log will be established that logs |
| | | | internal problems will devices for |
| | | | troubleshooting purposes. |
| | | Firmware Update | A function will be established that allow |
| | | | firmware updates through Expansion Bus or |
| | | | USB port on the device. |
| | Management | Converge Console | Converge Console will be the primary |
| | | | software application for configuration and |
| | | | management of the entire site to include the |
| | | | NetStreams enabled devices. |
| | | Telnet with ASCII | Telnet session with command processing of |
| | | | ClearOne ASCII API protocol. |
| | | HTML Web Pages | Web Based management console to perform |
| | | | simple configuration and status monitoring |
| | | | of the device. |
| | | SNMP Agent | Integrated SNMP agent that can be tied into |
| | | | Enterprise Management Console. |
| | | SMTP | Email events directly to maintenance |
| | | | personnel |
| | Communications | Ethernet | 10/100 Ethernet port for Network Audio |
| | | | using NetStream's technology. |
| | | USB | USB over IP connection for interfacing with |
| | | | Console Application |
| | | G-Link | Proprietary TDM bus at 24 MHz |
| | 3^{rd} | API Command | Text based command protocol for custom |
| | PartyControl | Protocol | programming of User interfaces by |
| | | | Crestron/Amx systems via Telnet Session |

| | |
|---|---|
| Other Items | Setting Device ID- We may need rotary switch to set Device ID in stack |
| | Power Indication LED- Front Power LED required for |
| | Rack Ear Kit- Need rack ear kit for mounting within 19″ Rack |
| | Mac Address- Need method to read Mac Address for allowing on corporate |
| | network |
| | Power Supply- POE Injector may be required or using a Wall wart. |

High Level Features of the Converge ProCom system are shown in Table 8.

TABLE 8
Converge ProCom Features

| | Sub- | | |
|---|---|---|---|
| Category | category | Feature | Description |
| General | General | Description | The Converge ProCOM is a device that |
| | | | enables the Converge Pro mixers to directly |
| | | | interface with USB Audio or Headset Audio |
| | | | associated with enterprise telephone sets. |
| | | | The device connects via the Expansion bus |
| | | | to a Converge Pro site. |
| | | USB Audio | USB 2.0 Stereo Transmit and Receive |
| | | | Channels |
| | | Headset Audio | RJ-9 interface with TX & RX audio |
| | | | emulating a Headset Port on an enterprise |
| | | | telephone set. |
| | | Wireless Control | 2.4 GHZ Wireless radio base to use with the |
| | | (Future) | Installed Controller. |
| | Converge | Number of | 4—ProCom Devices will be supported in a |
| | ProCom | Supported ProCom | single site. This allows for up to 8 USB |
| | Features | Devices | Audio Channels |
| | | | 18—Expansion Buses |
| | | | 8—AEC Ref Channels |
| | | | 6—Global Gating Group |
| | | Audio Channel | New audio channel types will be added to |
| | | Types | include USB and Headset types |
| | | OCS Support | An OCS API will be developed for the |
| | | | Converge Pro that will allow gain, mute, |
| | | | and dialing controls via the OCS client. |
| | | | These functions will be associated with the |
| | | | USB channels. |
| | Communications | USB 2.0 | USB 2.0 with Isochronous transfer. Type B |
| | | | connector |
| | | Expansion Bus | Link In and Link Out Port with RJ-45 |
| | | | connector |
| | USB Audio | Number | Stereo Transmit & Receive |
| | | Sample Rate | 48 KHZ with Sample Rate Conversion for |
| | | | independent timing between PC and |
| | | | Converge |
| | | Resolution | 24 bit |
| | | Driver | USB Audio Device |
| | | | OCS Audio Device |
| | | | USB HID Device |
| | | | Bulk Transfer (Firmware Loading) |
| | | | (Windows XP, Vista, Win 7, Mac OS 10) |
| | | HID Functions | Gain/Mute—gain and mute functions |
| | | | Dialing Controls—Dialing, On/Off Hook, |
| | | | Redial |
| | | | Firmware Update—Method for USB |
| | | | firmware update for driver specific |
| | | | functions. |
| | | | OCS or Standard USB Mode |
| | Expansion | I-Z Buses | 16—Expansion Bus to include both To |
| | Bus Audio | | (output) and From (input) channels that can |
| | | | be routed to network audio slots or usb |
| | | | audio slots. |
| | | Expansion Bus | 8—Expansion Bus Reference Channels. |
| | | References | Channels would be routed based in Network |
| | | | audio slots or USB audio slots |
| | | Global Gating | 6—Global Gating Groups |
| | | Groups | |
| | | Control Slot | 2—Control Slots for inner unit command and |
| | | | control. |
| | Headset | Coarse Gain | The coarse gain settings for the headset will |
| | Channel | | be based upon some pre-defined analog gain |
| | | Headset | Headset Configurations for Cisco, Avaya, |
| | | Configuration | Nortel |
| | | PinOut | Pinout for RJ-9 based upon manufacture |
| | | | headset port. |
| | | Fine Gain | −20 to 0 dB (Need to determine through |
| | | | testing) |
| | | Mute | Toggle On/Off for TX and RX |
| | | Receive ALC | Receive ALC |
| | | TEC | Line Echo Cancellation for side-tone |
| | | | elimination on headset port. |
| | | TEC NLP | Line Non-Linear Processing—Some phone |
| | | | configurations require only NLP to be |
| | | | enabled. |
| Processing | Matrix | Size | Inputs |
| | | | 16—Expansion Bus (From) |
| | | | 2—USB RX (Left &Right) |
| | | | 1—Headset RX |
| | | | 19 Total |
| | | | Output |
| | | | 16—Expansion Bus (To) |
| | | | 8—USB TX (Left & Right) |
| | | | 8—Expansion Bus Ref Channels |
| | | | 1—Headset TX |
| | | | 33 Total |
| | | Cross Point Control | +12 dB to −65 dB |
| | | Gated or Non- | Non-Gated Inputs |
| | | Gated | |
| | USB Audio | Volume | PC controlled volume |
| | Channels | Balance | PC Controlled Left & Right Balance |
| | | Mute | Global Mute |
| | Headset | Line Echo | Line Echo Cancellation for Side-tone |
| | Audio | Cancellation | elimination on unit |
| | | NLP | Non Linear Suppression for Side-tone |
| | | | elimination |
| | | NC | Receive Noise Cancellation |
| | | Gain | Digtial gain stage |
| | | Mute | Mute |
| | | Receive ALC | Receive ALC |
| | Converge | Scalability | Link up to 4-Converge ProCOM into a |
| | ProCom | | single site allowing. |
| | Configuration | Unit Settings | Unit setting will for the ProCOM device |
| | Functions | | will include device addressing and all |
| | | | communication setting for the device |
| | | Channel Settings | Channel Settings will include all properties |
| | | | associated with the USB, Headset and |
| | | | Expansion Bus audio channels. |
| | | Matrix Routing | Matrix routing will include all settings |
| | | | associated with audio routing from Input to |
| | | | Output channels |
| | | Macro | Up to 256 macros will be supported on the |
| | | | device |
| | | Presets | Up to 32 presets will be supported on the |
| | | | device |
| | | Event Scheduler | Up to 10 Events can be scheduled through |
| | | | the event scheduler function. |
| | | System Diagnostics | A system diagnostic function will be |
| | | | developed |
| | | | USB Audio Connection |
| | | Device Log | A device log will be included that allows |
| | | | user to enable disable recording of key |
| | | | events that may occur on the platform. |
| | | Event Log | An event log will be established that logs |
| | | | internal problems will devices for |
| | | | troubleshooting purposes. |
| | | Firmware Update | A function will be established that allow |
| | | | firmware updates through Expansion Bus or |
| | | | USB port on the device. |
| | Management | Converge Console | Converge Console will be the primary |
| | | | software application for configuration and |
| | | | management of the entire site. |
| | | Telnet with ASCII | Telnet session with command processing of |
| | | | ClearOne ASCII API protocol. |
| | | HTML Web Pages | Web Based management console to perform |
| | | | simple configuration and status monitoring. |
| | | SNMP Agent | Integrated SNMP agent that can be tied into |
| | | | Enterprise Management Console. |
| | | SMTP | Email events directly to maintenance |
| | | | personnel |
| | Communications | USB | USB over IP connection for interfacing with |
| | | | Console Application |
| | | G-Link | Proprietary TDM bus at 24 MHz |
| | | Radio (Future) | 2.4 GH DSSS Radio to Tabletop Controller |
| | 3^{rd} Party | API Command | Text based command protocol for custom |
| | Control | Protocol | programming of User interfaces by |
| | | | Crestron/Amx systems via Telnet Session |

| | |
|---|---|
| Other Items | Setting Device ID - We may need rotary switch to set Device ID in stack |
| | Power Indication LED - Front Power LED required for device |
| | Rack Ear Kit - Need rack ear kit for mounting within 19″ Rack |
| | Power Supply - POE Injector may be required or using a Wall wart. |

The Converge ProStream Beamforming Microphone (BFM) system includes a beam-forming nicrophone with an integrated acoustical echo canceller. The system also includes a low cost USB version for unified communication with a PC and Professionally installed A/V systems. Applications for this system include telepresence, video conferencing, and general teleconferencing. Some benefits of the Converge ProStream BFM include:

Minimizes Room Noise & Reverberation improving speech intelligibility for conferencing.
Connects to Converge ProStream Audio Codec for direct interface to network audio.
Integrated Multi-channel echo cancellation for telepresence and zoned applications.
Stereo Microphone Image Output for creating Spatial Audio to Far-End.
Expandable to 8-Units for Larger Applications.
Improved Pickup Converged.
   360 degrees.
   Typical Pickup Range of 10-12 Feet.
Stream Audio digitally using the Converge Pro Stream device.
Installation Flexibly.
   Ceiling or Wall.
   Table.
   Wall Mounted.
   Sleek Low Profile Design minimizes visual presence on table and eliminates need to drilling associated with Button Microphone installation.

High Level Features of the Converge ProStream BFM system are shown in Table 9.

TABLE 9
Converge ProStream BFM High Level Features

| | Sub- | | |
|---|---|---|---|
| Category | category | Feature | Description |
| General | General | Description | .The BFM is the industry's first |
| | | | Beamforming Microphone with integrated |
| | | | Acoustical Echo Cancellation. Reduces |
| | | | room noise and Reverb effects to improve |
| | | | overall speech intelligibility for |
| | | | conferencing. |
| | Versions | PC | The PC-based BFM product line is intended |
| | | | to Unified Communication application that |
| | | | utilizes the Personal Computer (PC). |
| | | | Primary communications interface is USB. |
| | | | This version does not allow for expansion or |
| | | | network audio |
| | | PRO | The Converge ProStream BFM product line |
| | | | is intended for use with ClearOne |
| | | | Professional conferencing product and |
| | | | applications requiring custom installation |
| | | | and scalability. It connects to the Converge |
| | | | Pro product line via the ProStream network |
| | | | audio device. |
| | Installation | Table Mount | The Table Mount is targets for installation at |
| | Options | | the center of the conference table parallel to |
| | | | the length of the table. |
| | | Ceiling Mount | The Ceiling Mounted option utilizes a |
| | | | mounting system that hangs the BFM |
| | | | approximately 6″ from the ceiling. |
| | | Wall Mount | The desire would be to use the same |
| | | | mounting system for the wall as the ceiling. |
| | | Plasma Mount | TBA |
| | Expansion | Maximum Units | 8—Units in Mono Mode or 4-units in Stereo |
| | Capability | | Mode |
| | | Interface Cable | RJ-45 CAT5/24 |
| | | Maximum Distance | Standard Ethernet |
| | Array | Elements | 12 or 24 Omni-directional microphones |
| | | | elements |
| | | Directional Beams | 8 total |
| | | Typical Directivity | 45 degrees |
| | Operational | Linear/Mono | This operation mode provides a single |
| | Modes | | Microphone channel output. |
| | | Stereo Image | This operational mode creates an Left and |
| | | | Right Microphone Channel output. The |
| | | | stereo image is created perpendicular to the |
| | | | linear array. The Right Channel will |
| | | | include the center beams. |
| | | Stereo with | This operation mode allows the user to route |
| | | Multiple Unit | a BFM output from an Expansion Unit to |
| | | | either the right or left channel. |
| | | Notch | Notch beams that contribution is not |
| | | | desirable in the room application |
| | Other | Mute Button | Mute Button located in center of array |
| | | LED Gate | LED Circular Array that designates |
| | | Indicators | direction of beamforming receive audio. |
| | | | Also allow Mute indications (flashing red) |
| | | | and Notched Beams(solid red) |
| Signal Processing | AEC | Multi-channel | Maximum of 3-channels (Telepresence |
| | | | application) |
| | | Bandwidth | 20 HZ to 20 KHz |
| | | Tail Time | >120 msec for primary voice bands |
| | | AEC References | Up to 3 channels (May drop to Stereo based |
| | | | upon processing) |
| | | AEC Metering | TERLE, ERL and Total ER will be |
| | | | provided. |
| | NLP | User Selectable | User selectable between soft, medium, and |
| | | | aggressive. |
| | | Advanced Mode | TBA—Potential advanced mode for custom |
| | | | configuration based on room acoustics |
| | | | (adjusting attack depth, release time, |
| | | | detector sensitivity, etc) |
| | Noise | Depth | A noise cancellation algorithm will be |
| | Cancellation | | developed with a depth up to 20 dB. Steps |
| | | | will be in 6 dB increments. |
| | Gain | ALC | An automatic gain function will be |
| | Controls | | developed for the Mic array that |
| | | | dynamically adjusted audio for maximum |
| | | | intelligibility. |
| | | Manual Gain | A manual digital gain stage will be |
| | | | developed that functions as a singular |
| | | | control for all elements. |
| | | Mute | Two mute function will allow be created. |
| | | | Master Mute that mutes all units and an |
| | | | individual mute that mutes a single unit |
| | Filter Bank | General | The desire is to create a generic filter bank |
| | | | that would be applied to the overall BF |
| | | | Microphone as a single element. The intent |
| | | | of this filter bank is to allow installer to EQ |
| | | | microphone based upon room conditions |
| | | | (Air Handlers, Equipment, Etc) |
| | | Filter Types | High Pass, Low Pass, Notch, Band Pass |
| | Beam- | Mode | Stereo Image, Mono, Stereo Link, Notch |
| | forming | Stereo Image | This operation would create a left and right |
| | | | channel based upon splitting audio from |
| | | | different beams |
| | | Stereo Link | This would be a mode to route a unit to RT |
| | | | channel and other unit to Left the other |
| | | | channel. |
| | | Notch | This would mute specific beams in the array |
| | | | so they would not contribute. |
| | Gating | Gating on | The multichannel gating will be provided on |
| | | Converge | the Converge ProStream Device. This will |
| | | ProStream Device | be the equivalent to 1^{st} Mic priority scheme |
| | | | with each BFM device acting as a single |
| | | | element in the gating mixer. |
| | | BeamGating | There may be a need for some beam |
| | | | controls as it pertains to multiple talkers at |
| | | | the local end |
| | Adaptive | Mode | Normal, Noisy, Off |
| | Ambient | Noisy | This setting would create different threshold |
| | | | value for Noise Floor that may typically be |
| | | | found in an ceiling installation. |
| | Metering | Line Inputs | Metering level will be provided to the |
| | | Line Outputs | firmware application layer for display on the |
| | | AEC Meters | user interfaces. |
| Controls/Configuration | Controls | Physical | Mute Button and LED Indications on Gate |
| | | Software | Unit Mute and Global Mute |
| | | | Beam Gate Information |
| | | | Low Power Mode |
| | | | RTSP Functions (Record, Playback, Stream) |
| | | | Gain and Noise Cancellation |
| | | | Metering |
| | Config. | Network Settings | The user will be able to configure all |
| | | | network settings to include unit addressing. |
| | | Audio Settings | The user will be able to configure all audio |
| | | | settings on the BFM |
| | | Encoder Settings | The user will be able to configure all |
| | | | encoder settings for the BFM |
| | | Operational Mode | The user will be able to set operation mode |
| | | Settings | of the Beamforming array based on desire |
| | | | application performance and room |
| | | | installation. |
| | | USB Mode | The user will be able to distinguish between |
| | | | OCS Mode and standard USB mode. |
| | Provisioning | Firmware Updates | A method will be developed to allow for |
| | | | field upgrades of firmware on the master |
| | | | units and slave devices. |
| | | Device Discovery | A method will be developed for responding |
| | | | to discovery request from the User Interface |
| | | | Devices (Controller & Software) |
| | | Device Addressing | A method will be developed to unique |
| | | | identify a device and also group device to a |
| | | | room. |
| | Other | Power Savings | A function will be created to initiate a |
| | | Mode | power savings mode with the microphone. |
| Communications | Ethernet | Control | ASCII Command Protocol |
| | | Audio | Audio Transport Method will be Network |
| | | | Audio using StreamNet technology. |
| | | Telnet | A telnet session will be supported with the |
| | | | serial command protocol for AMX/Crestron |
| | | | Controls. |
| | USB | Control | HID Control Function may include all |
| | | | parameters for configuration and control of |
| | | | the microphone |
| | | Audio (For PC | The USB audio will need to support 2- |
| | | Version) | Transmit and 3-Receive channels from the |
| | | | PC. The Receive channels will need to |
| | | | duplicate those designated as the |
| | | | “Loudspeaker's” Sample rate will be 48 KHz |
| | | | and 24 bit resolution and Isochronous |
| | | | transfer. |
| | | Drivers | XP, Vista, Window 7, Windows 14, and |
| | | | OCS Variants |
| Connectors | USB | Type B | Type B USB for Configuration |
| | RJ-45 | LAN | The LAN connection will be RJ-45 with |
| | | | activity LEDs. |
| | Power | 3.5 Barrel | Power connector for USB version with |
| | | | center positive. |
| Other | Power | | A reduce power saving mode will be |
| | Savings | | developed for the entire product line |
| | Mode | | |
| | RF | | The microphone must be designed to |
| | Immunity | | minimize RF artic fact created by PDA |
| | | | devices that may be place on the table. |
| | Power | POE | The BFM will power supply will be Power |
| | Supply | | Over Ethernet. |

Some of the new features included in the complete Converge Pro group of systems, including Converge ProStream, Converge ProStream BFM, and Converge ProCOM are list in Table 10.

TABLE 10
Converge Pro New Features

| | Sub- | | |
|---|---|---|---|
| Category | category | Feature | Description |
| System | General | General | The Converge ProStream development |
| | | | project will be part of a new revision for the |
| | | | entire Converge Pro product line. The |
| | | ProStream Unit | A new unit type for the Converge ProStream |
| | | Type | device will be created within the software. |
| | | ProCom Unit Type | A new unit type for the Converge ProCOM |
| | | | device will be created within the software. |
| | | ProStream BFM | A new unit type for the ProStream BFM |
| | | Type | will be created within the software. These |
| | | | will be identified as children devices for the |
| | | | ProStream device. |
| | | Site ID | A site ID will be developed allowing the |
| | | | association of Network Audio children |
| | | | devices to a specific Converge Pro Site |
| | | | Identification. |
| | | Audio Channel | New audio channel types will be added to |
| | | Types | include USB, Headset, and Network. |
| | | OCS Support | An OCS API will be developed for the |
| | | | Converge Pro that will allow gain, mute, |
| | | | and dialing controls via the OCS client. |
| | | | These functions will be associated with the |
| | | | USB channels. |
| | Audio | 3-Channel AEC | A new mode will be added on the 880T, |
| | | | 880, 8i, and 880TA that will allow a 3- |
| | | | channel AEC on microphones channels 1-4. |
| | | | In this mode channels 5-8 will become |
| | | | inactive. |
| | | Network Audio | A network audio channel will be added to |
| | | | the signal processing. |
| | | USB Audio | A USB stereo audio channel will be added |
| | | | to the signal processing |
| | | Headset Audio | A headset audio channel will be added to |
| | | | the signal processing |
| | | Pre-AEC Non | A new mode will be added that will allow |
| | | Gated Route Option | user to set the Pre-AEC route as a non-gated |
| | | | input. This will be a unit proprietary. |
| | Software | Site Address Book | A site address book will be added to the |
| | | | Converge Pro to allow a site record to be |
| | | | generated that will include IP Address for |
| | | | connection by Console application. |
| | | Site View | A vector based site view will be added to |
| | | | the console application. The Site View will |
| | | | depict the audio net list for all devices |
| | | | within the site. |
| | | Group View | A new Group View depicting all channels |
| | | | within the specified group will be added to |
| | | | all current devices. |
| | | Unit View | All flash based components associated with |
| | | | the Unit View will be removed and |
| | | | rewritten for Delphi. |
| | | Automated Update | Feature to check ClearOne web site for new |
| | | Notification | updates that may be available. Based upon |
| | | | firmware and/or Console software update. |
| Enhancements | Phonebook | Object | Create a phonebook object and allow |
| Requests | | | import/export to site. |
| | Printing | Schedule Events | Add Scheduled Event to the print |
| | | | engine |
| | | PA Channel | Add PA channel report to the print |
| | | | engine |
| | | FBE Node Report | Add Feedback Elimintor Node |
| | | | report to the print engine |
| | Telco | Country Setting to | Move the telephone country settings |
| | Settings | Telco Tab | from the unit property page to the |
| | | | telephone setting property page. |

Communications Connections

One or more USB ports may be included for audio and control devices.

### Ethernet

AN Ethernet jack connection may be configured as an RJ-45 jack with status LED to depict network activity. The ProStream and BFM will support 10/100 Ethernet speeds. An expansion bus will include an RJ-45 connector designated as either Link In or Link Out.

Expansion Bus Physical Connection

| | |
|---|---|
| Connector | RJ-45 |
| Physical Layer | LVDS |
| Maximum Distance | 200 feet |
| Between Units | |
| Cable | CAT 5 or better, 26 Gauge |
| | Solid Conductor |

Expansion Bus Audio Channels

| | |
|---|---|
| Bus Type | Synchronous Time Division Multiplexed |
| Structure | Mix-Minus |
| Minimum Number | Glink 1—24 Slots Up & Down |
| of Channels | Glink 2—24 Slots Up & Down |
| Channel Resolution | 24 Bit |
| Sample Rate | 48 kHZ |

Expansion Bus Control Channels

| | |
|---|---|
| Bus Type | Synchronous |
| Structure | Dedicated Control Slots |
| | in TDM Bus |
| Minimum Number | 1 channel |
| of Channels | |

Software and Firmware

The ProStream systems include firmware functions within the Converge Pro product family to facilitate utilization of network audio in conference room applications. Major

### Call Control for Multichannel Transport (Over LAN)—

One functions of the ProStream systems is a call and transport protocol that allow spatial audio conferencing within a local area network or campus topology. The call protocol may include a notification scheme to invite other conference rooms that would be ProStream enabled and on the local area network. A list of the functions is contained in Table 11.

TABLE 11
Mutli-channel Call Protocol

| Category | Command | Function | Description |
|---|---|---|---|
| Call State | INVITE | Initiating a call | Sends an Invite to a ProStream Network |
| | | | enabled room via an defined address. Invite |
| | | | will include originator and destination |
| | | | address in the message. |
| | INCOMING | Notification of | Notifies ProStream device has been invited |
| | | Invite | by another room. Also generates audible |
| | | | ringing within the room. |
| | ACCEPT | Accepts and | Accepts an incoming call. Sends notification |
| | | Inbound Call | back to Invitee. Starts playing audio streams |
| | | | on both sides. |
| | REJECT | Notifies that | Far End rejects invitation and not audio |
| | | invitee has | streams are set up. |
| | | rejected invitation | |
| | BUSY | Notifies that room | Far-end does not respond to request. Set |
| | | is not responding | after a fixed number of rings without |
| | | to request for | acknowledgment |
| | | conference. | |
| | END | Turns off Audio | Turn's off audio streams to/from the local |
| | | Streams and | end. Sends notification to far-end that call is |
| | | terminates call | terminated. |
| | INUSE | Current Channels | Notifies the Invitor that the network channels |
| | | are in use | are in use for another call. (Applies if |
| | | | multiple rooms are in same group) |
| | JOIN | 3-Way Call | Invites another participant into the call. |
| | (Future) | | Requires local ProStream device to create |
| | | | Mix-Minus for TX and RX. Requires setup |
| | | | of additional Bridge Channel with |
| | | | configuration. (Only Mono or Stereo can be |
| | | | supported with 3-Way calling) |
| CALL | CMODE | Sets the number | Sets the number of audio channels to be used |
| CONFIG | | of channels to be | in the calling function. Allows 1, 2, or 3. |
| | | used | |
| | BMODE | Enable Bridge | Enables Bridge Mode. |
| | (Future) | Mode | |
| | CCHAN | Sets the channels | Sets the channels to be used for calling |
| | | to be used for | within the local area network. Values are 1-8 |
| | | calling | TX and 1-8 RX. |
| | BCHAN | Set the channels | Sets the TX & RX channels for the Bridge |
| | (Future) | to be used for | operation. Local ProStream device would |
| | | bridging | create the TX mix for bridge call |
| | | broadcast | |
| | CGROUP | Sets the Call | Sets the ProStream devices that can use call |
| | | Group | channels for conferencing within the |
| | | | network. Based upon Device Name & Type. |
| ADDRESS | | HOSTNAME | Host name for the device and used for |
| | | LABEL | Label for the Room |
| | | IP Address | IP Address of the device |
| | | Multicast IP | Multicast IP address used for network audio |
| | | Address | |

A number of Address/Phonebook functions may be included in the Converge Pro system family to assist in site management and call initiation for the functions associated with the network audio.

A site address book may be included to allow maintenance personal to create a record entry of IP Addresses, Domain Name and hostnames of Converge Pro Sites that may be within a set enterprise.

A room address book may be included and associated with the multichannel transport protocol. This room address book may be used in the call protocol to initiation a spatial audio session. Each record may include IP addressing, device label and number of audio channels available for the room.

Multichannel Acoustical Echo Cancellation

The Converge Pro eight channel systems may include a DSP mode that allows for a 3-channel AEC on microphone inputs 1-4. In the multichannel AEC mode, microphone inputs 5-8 and processing channel E-H. The AEC Mode may be a unit property on the 8-channel mixers that is set at configuration. The implementation of the AEC Mode within the firmware architecture can be accomplished by disallowing commands associated with the disabled channels when in the multichannel mode. With this method, the User Interfaces (Web, Console, Front Panel may grey out the channels to represent non-available channels. In this implementation scheme, the recommendation is to generate a “Not Available” message instead of argument error. The recommendation would be to keep the same configuration file for the complete 8 channels but just deactivate if AEC Mode is set to multichannel. This function would also be available as a Preset configuration with the unit.

Table 12 outlines some of the AEC software objects.

TABLE 11
AEC Software Objects

| Object | Item | Description |
|---|---|---|
| Unit Object | AEC Mode | Sets the AEC mode to either |
| | | Normal or Multichannel AEC |
| | | operations |
| Microphone | AECREF1 | Sets Reference for 1^{st} AEC |
| Object | | block |
| | AECREF2 | Set Reference for 2^{nd} AEC |
| | | Block |
| | AECREF3 | Set Reference for 3^{rd} AEC |
| | | Block |
| MATRIX | MIC Channel 5-8 | Channel listed will be disable |
| Object | Processing Channel E-H | when unit property is set to |
| | Gating Channels 5-8 | multichannel AEC Mode. |
| Echo | Meter | EC meters will remain the |
| Cancellation | | same at the presentation layer |
| Meter | | (DSP will handle any changes |
| | | to calculation methods. |

High-Level Firmware Architecture

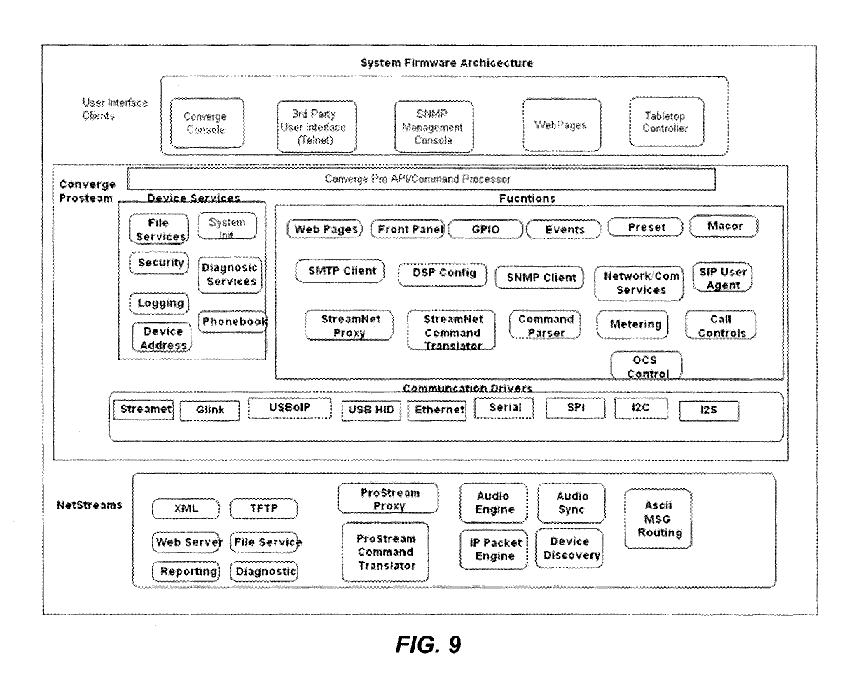

FIG. 9 illustrates a high-level firmware architecture.

StreamNet Proxy

A StreamNet Proxy function provides a method to allow relay inherent StreamNet command and response functions through the ClearOne API to the Console Software application. This function basically provides a wrapper function within the protocol layer to relay pure StreamNet command/response to the device. This function will be used for system services Table 12 outlines some of the StreamNet Proxy functions.

TABLE D.2.1.1
StreamNet Proxy Functions

| Functions | Description |
|---|---|
| Firmware Update for | Provides the method to update firmware on the |
| StreamNet Card | StreamNet circuit on the ProStream device. |
| | Firmware update would be intitiated from |
| | the Console application and follow existing |
| | protocol found on Dealer Setup. |
| Configuration File | Provides a method to update device configuration |
| | from the Console application with minimal |
| | changes to NetStream device. |
| Time Sync | Need to find out more on this function |
| Multicast Address | Need to find out more on this function |
| Management | |
| Status Reporting | Status reporting would remain the same as |
| | implemented on StreamNet. |

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A method for unified communication, comprising:
transmitting a communication from a first network connected device; and;
receiving the communication at a second network connected device.

2. A communication apparatus, comprising:
one or more communication interfaces;
a memory configured for storing computing instructions;
a processor operably coupled to the one or more communication interfaces and the memory, the processor configured to execute the computing instructions to cause the communication apparatus to send, receive, or a combination thereof information to another communication apparatus.

3. Computer-readable media including instructions, which when executed by a processor, cause the processor to send, receive, or a combination thereof information to a communication apparatus.
